(19) United States
(12) Patent Application Publication
(10) Pub. No.: US 2008/0235441 A1
(43) Pub. Date: Sep. 25, 2008

(54) Reducing power dissipation for solid state disks

(76) Inventor: Itay Sherman, Hod Hasharon (IL)

Correspondence Address: Soquel Group, LLC, P.O. Box 691, Soquel, CA, 95073, US

(21) Appl. No.: 11/975,854

(22) Filed: Oct. 22, 2007

Related U.S. Application Data
(60) Provisional application No. 60/918,966, filed on Mar. 20, 2007.

(51) Int. Cl. G06F 12/00

(52) U.S. Cl. 711/103; 711/E12.001

(57) ABSTRACT

A data processing device including a computer, the computer including a solid state disk (SSD), including a primary memory for single level cell storage, and a secondary memory for multi-level cell storage, a limited internal battery for supplying power to the computer, a socket for connecting the computer to an external power supply source, a detector for indicating that the computer is connected to an external power source, a processor for transferring data from the primary memory to the secondary memory, and an SSD controller for deciding whether or not the processor may transfer data from the primary memory to the secondary memory, based on a signal received from said detector. A method for SSD memory management is also described and claimed.

### PRIORITY REFERENCE TO RELATED APPLICATIONS

This application claims benefit of U.S. Provisional Application No. 60/918,966, entitled REDUCING POWER DISSIPATION FOR SOLID STATE DISKS, filed on Mar. 20, 2007 by inventor Itay Sherman.

### FIELD OF THE INVENTION

The present invention relates to solid state disks.

### BACKGROUND OF THE INVENTION

Advances in solid state disk (SSD) technology are leading to SSDs that may replace conventional hard disks in notebook computers and other portable computing devices. SSD memory is expected to be larger than conventional hard disk memory, SSD access and seek times are expected to be faster than hard disk access and seek times, and SSD operation is expected to consume less power than hard disks, resulting in longer battery life.

Conventional SSDs are used within computers, such as portable laptop and notebook computers, personal data assistants (PDAs), media players, digital cameras and cell phones. Such SSDs store data in memory cells, with single cells storing single bits. Recently it has been found that SSD storage may be improved from such single-level cell (SLC) storage to a more compact storage, referred to as multi-level cell (MLC) storage, that enables storage of 4-bits or more per SSD cell. Briefly, using MLC technology, data written to the SSD is first stored in a primary memory as SLC flash memory storage. Thereafter, the data undergoes compression and is augmented with error code correction (ECC) data, and is transferred to a secondary memory as MLC storage. Thus the computer processor for the SSD does not write data directly to MLC storage, but instead transfers data from SLC memory to MLC memory in background, when the computer processor is not busy with other operations.

A disadvantage of MLC storage is that the transfer of data from SLC to MLC requires significant computing power over relatively long times, and thus consumes a significant amount of power. When the computer is running on a battery, the SLC to MLC transfer results in shorter battery life.

### SUMMARY OF THE DESCRIPTION

The present invention relates to portable computers that use SSD memory. The portable computers include inter alia laptop and notebook computers, PDAs, portable media players, digital cameras and mobile telephones. The present invention provides for improved MLC storage that conserves battery life better than conventional MLC storage, thus enabling a user to enjoy his portable computer for longer periods of time while the computer is running on a battery.

Using the present invention, an SSD controller within the computer is used to govern when data may be transferred from SLC memory to MLC memory. When data is first written in the computer to SSD memory, the data is stored in a non-condensed mode; namely, in SLC mode, which is the fastest mode of SSD storage. When the computer is connected to an external power supply, the controller decides to enable data compression and ECC generation to be performed in background, to transfer data from primary SLC memory to secondary MLC memory. The controller may also decide to enable transfer to secondary memory if the remaining free space available in the SSD is low.

In a first embodiment of the present invention, the computer provides a signal to the SSD controller indicating whether the computer is connected to an external power source. In a second embodiment of the present invention, the SSD controller independently verifies the nature of the power source by monitoring and analyzing the supply voltage level.

There is thus provided in accordance with an embodiment of the present invention a data processing device including a computer, the computer including a solid state disk (SSD), including a primary memory for single level cell storage, and a secondary memory for multi-level cell storage, a limited internal battery for supplying power to the computer, a socket for connecting the computer to an external power supply source, a detector for indicating that the computer is connected to an external power source, a processor for transferring data from the primary memory to the secondary memory, and an SSD controller for deciding whether or not the processor may transfer data from the primary memory to the secondary memory, based on a signal received from said detector.

There is additionally provided in accordance with an embodiment of the present invention a method for solid-state disk (SSD) memory management, including providing a SSD within a computer, the SSD including a primary SSD memory for single level cell storage, and a secondary SSD memory for multi-level cell storage, wherein power may be supplied to the computer from an external power supply source or from a limited internal battery, determining if the computer is connected to an external power source, and if the determining determines that the computer is connected to an external power source, then enabling transfer of data from the primary SSD memory to the secondary SSD memory.

### BRIEF DESCRIPTION OF THE DRAWINGS

The present invention will be more fully understood and appreciated from the following detailed description, taken in conjunction with the drawings in which:

FIG. 1 is a simplified block diagram of a portable computer including an SSD memory, in accordance with an embodiment of the present invention; and

FIG. 2 is a simplified flowchart of a method for SSD memory management, in accordance with an embodiment of the present invention.

### DETAILED DESCRIPTION

The present invention relates to solid state storage devices that include multi-level cell memory, and more specifically to conserving power when such devices are powered by a limited internal battery.

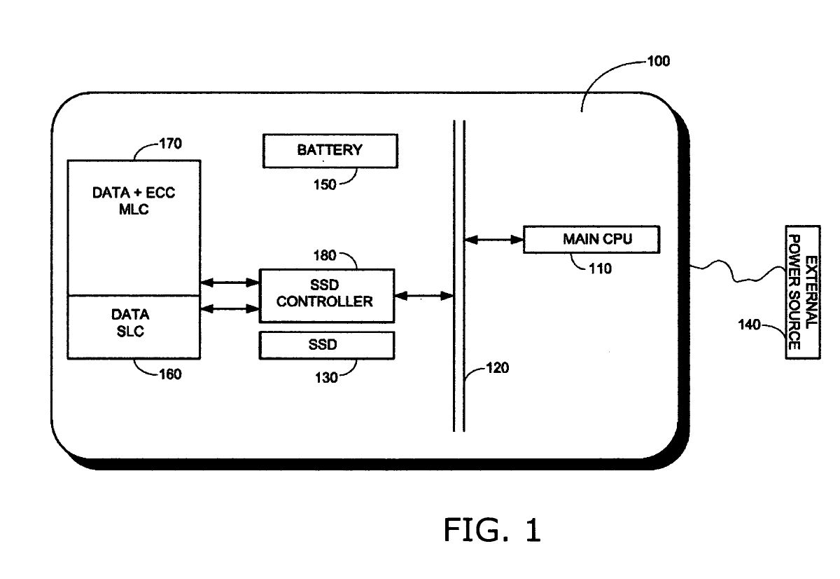

Reference is now made to FIG. 1, which is a simplified block diagram of a portable computer including an SSD memory, in accordance with an embodiment of the present invention. Shown in FIG. 1 is a portable computer 100 including a main central processing unit (CPU) 110, a data bus 120 for inter-communication, and an SSD memory 130. Computer 100 may be a laptop or notebook computer, a PDA, a digital camera, an MP3 player, a mobile telephone, or such other portable data processing device.

Computer 100 may be connected to an external power source 140, when such power source is available. Computer 100 also includes an internal battery 140 which provides a limited source of power when computer 100 is not connected to an external power source.

SSD memory 130 is able to store data in a primary memory 160 and in a secondary memory 170. Primary memory 160 is generally a single-level cell (SLC) memory that stores one bit per SSD cell. Secondary memory 170 is generally a multi-level cell (MLC) memory that stores four or more bits per cell.

SLC memory provides the fastest mode of data storage in terms of access and seek times. MLC memory is more complex than SLC memory. In order to store data in MLC memory, the data must be compressed and error correction code (ECC) must be attached to the data. The data compression and ECC generation require significant computing resources over relatively long periods of time and, as such, consume a lot of power.

When SSD memory 130 receives data, the data is first written to SLC memory 160. Subsequently CPU 110 compresses the data and generates the ECC in background; i.e., when CPU 110 is not busy processing other operations. As such, the data stored in MLC memory 170 is not written directly to MLC, but instead is first written to SLC memory 160 and subsequently transferred to MLC memory 170 in background. Such SLC-to-MLC data transfer is generally done in units of SLC data blocks.

When computer 100 is running on its internal battery power supply, SLC-to-MLC data transfer consumes a significant amount of power and accordingly reduces the lifetime of battery 150. As such, it is preferable to avoid such data transfer when computer 100 is not connected to external power supply 140. On the other hand, if SLC-to-MLC data transfer is stopped, then SLC memory 160 may fill up to its capacity, resulting in no free available memory to store new data. Thus, it is preferable to perform SLC-to-MLC data transfer when SLC memory 160 is nearly filled to its capacity, in order to free up memory.

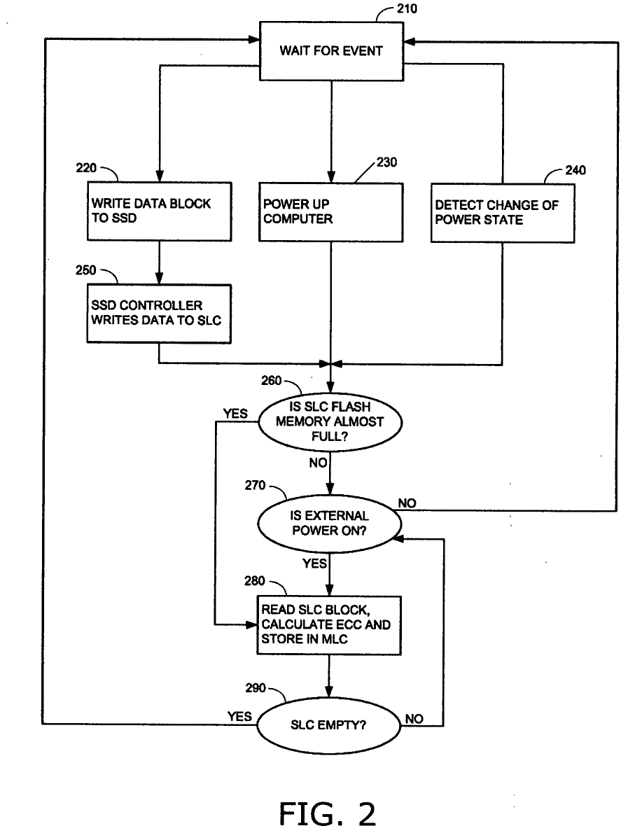

To this end, an SSD controller 180 is operative to govern when SLC-to-MLC data transfer may be performed. At each of a plurality of specific times, including inter alia times when any of events 220, 230 and 240 from FIG. 2 occur, as described hereinbelow, SSD controller 180 determines if computer 100 is connected to external power source 140, and determines the amount of available free SLC memory, and decides based upon this information whether or not to allow SLC-to-MLC data transfer to be performed.

In a first embodiment of the present invention, SSD controller 180 receives a signal from CPU 110 indicating whether or not computer 100 is currently connected to external power source 140. In a second embodiment, SSD controller 180 monitors its voltage supply. If the voltage level increases beyond a designated threshold, then computer 100 is likely connected to external power source 140, since battery 150 generally provides a fixed voltage level that eventually decreases as the charge of battery 150 is drained.

Reference is now made to FIG. 2, which is a simplified flowchart of a method for SSD memory management, in accordance with an embodiment of the present invention. As shown in FIG. 2, at step 210 the method waits for any one of three independent events 220, 230 and 240 to occur, each of which triggers a determination whether or not to allow SLC-to-MLC data transfer to be performed. Event 220 occurs when a data block is written to an SSD, such as SSD 130 of FIG. 1. Event 230 occurs when a computer, such as computer 100 of FIG. 1, is turned on. Event 240 occurs when a change of power state is detected. As described hereinabove with reference to FIG. 1, a change of power state may be detected by a CPU such as CPU 110 of FIG. 1, or by monitoring a voltage supply and detecting when the voltage level exceeds a designated threshold.

At step 250 an SSD controller, such as controller 180 of FIG. 1, writes data to a single-level cell flash memory, such as SLC memory 160 of FIG. 1. At step 260 a determination is made whether the SLC is almost full. If not, then at step 270 a further determination is made whether the computer is connected to an external power source, such as external power source 140 of FIG. 1. If so, then at step 280 data transfer from SLC memory to multi-level cell memory, such as MLC memory 170 of FIG. 1, is enabled. An SLC data block is read and compressed, and error correction code is generated, and the resulting compressed data and ECC is stored in MLC memory.

At step 290 a determination is made whether the SLC memory is empty. If so, then there is no data left to be transferred from SLC memory to MLC memory, and processing returns to step 210 to wait for another trigger event. Otherwise, if SLC memory is not empty, then processing returns to step 270.

If it is determined at step 260 that the SLC memory is almost full, then SLC-to-MLC data transfer is enabled, and processing advances to step 280. If it is determined at step 270 that the computer is not connected to an external power source, then SLC-to-MLC data transfer is disabled and processing returns to step 210 to wait for another trigger event.

In reading the above description, persons skilled in the art will realize that there are many apparent variations that can be applied to the methods and systems described.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A data processing device comprising a computer, the computer comprising:
a solid state disk (SSD), comprising:
a primary memory for single level cell storage; and
a secondary memory for multi-level cell storage;
a limited internal battery for supplying power to said computer;
a socket for connecting said computer to an external power supply source;
a detector for indicating that said computer is connected to an external power source;
a processor for transferring data from said primary memory to said secondary memory; and
an SSD controller for deciding whether or not said processor may transfer data from said primary memory to said secondary memory, based on a signal received from said detector.

2. The data processing device of claim 1 wherein said SSD controller decides whether or not said processor may transfer data from said primary memory to said secondary memory based on available free space in said primary memory.

3. The data processing device of claim 1 wherein said detector comprises a voltage monitor for monitoring the voltage level supplied to said SSD.

4. A method for solid-state disk (SSD) memory management, comprising:
providing a SSD within a computer, the SSD including a primary SSD memory for single level cell storage, and a secondary SSD memory for multi-level cell storage, wherein power may be supplied to the computer from an external power supply source or from a limited internal battery;
determining if the computer is connected to an external power source; and
if said determining determines that the computer is connected to an external power source, then enabling transfer of data from the primary SSD memory to the secondary SSD memory.

5. The method of claim 4 further comprising:
determining an amount of available free space in the primary SSD memory; and
if said determining determines that the available free space in the primary SSD memory is below a designated amount, then enabling transfer of data from the primary SSD memory to the secondary SSD memory.

6. The method of claim 4 wherein said determining comprises monitoring a voltage level supplied to the SSD.
